(19) United States
(12) Patent Application Publication
(10) Pub. No.: US 2026/0332996 A1
(43) Pub. Date: Oct. 22, 2026

(54) IN-VEHICLE DEVICE, CONTROL METHOD, AND STORAGE MEDIUM

(71) Applicants: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(72) Inventors: Mayuu IWASAKI, Osaka-shi (JP); Akihiro OGAWA, Osaka-shi (JP)

(73) Assignees: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(21) Appl. No.: 19/113,139

(22) PCT Filed: Aug. 8, 2023
(86) PCT No.: PCT/JP2023/028859

§ 371 Date: Mar. 19, 2025

(30) Foreign Application Priority Data
Sep. 20, 2022 (JP) 2022-148752

(51) Int. Cl. H04W 4/38; H04W 4/44; H04W 72/1268

(52) U.S. Cl. CPC H04W 4/38; H04W 4/44; H04W 72/1268

(57) ABSTRACT

An in-vehicle device mounted in a vehicle, the in-vehicle device including: a communication unit configured to communicate with an external device, and transmit, to the external device, sensor data detected by a sensor mounted in the vehicle; and a processor configured to determine, according to a speed of wireless communication with the external device performed by the communication unit, whether to perform buffering in which the sensor data is stored in a memory without being transmitted by the communication unit, and perform the buffering according to a result of the determination.

### BACKGROUND

The present disclosure relates to an in-vehicle device, a control method, and a computer program. This application is based upon, and claims the benefit of, priority from the corresponding Japanese Patent Application No. 2022-148752 filed on Sep. 20, 2022, the entire contents of which are incorporated herein by reference.

Systems that aggregate sensor data from many sensors in a server computer (hereinafter referred to as a “server”), analyze the data, and use the results of the analysis for driving assistance are coming into widespread use. The sensor data is transmitted from a sensor mounted in a vehicle, and a sensor (hereinafter referred to as an “infrastructure sensor”) included in an infrastructure provided on the roadside. In such a system, the vehicle performs communication with the server via a wireless base station. Vehicles having a wireless communication function also can perform direct communication (so-called vehicle-to-vehicle communication) between the vehicles without the server intervention. In the vehicle-to-vehicle communication, sensor data of a vehicle is transmitted to another vehicle, or information held by a vehicle is transmitted to another vehicle.

JP 2003-61149A below discloses an in-vehicle device (in-vehicle communication control device) having a function of performing wireless communication with the outside of the vehicle. The in-vehicle communication control device communicates with a content provider located outside the vehicle. The in-vehicle communication control device enables stream-type content to be reproduced without interruption even in a section in which such content cannot be sufficiently downloaded due to a poor radio wave environment of a scheduled travel route of the vehicle. For this purpose, the in-vehicle communication control device of JP 2003-61149A performs buffering for reproducing downloaded data. The in-vehicle communication control device calculates the amount of data that can be buffered, taking the traveling speed of the vehicle into account, and determines whether downloading can be performed.

### SUMMARY

An in-vehicle device according to a certain aspect of the present disclosure is an in-vehicle device mounted in a vehicle, the in-vehicle device including: a communication unit configured to communicate with an external device, and transmit, to the external device, sensor data detected by a sensor mounted in the vehicle; and a processor configured to determine, according to a speed of wireless communication with the external device performed by the communication unit, whether to perform buffering in which the sensor data is stored in a memory without being transmitted by the communication unit, and perform the buffering according to a result of the determination.

### BRIEF DESCRIPTION OF THE DRAWINGS

FIG. 1 is a schematic diagram showing a utilization form of an in-vehicle device according to an embodiment of the present disclosure.

FIG. 2 is a block diagram showing a hardware configuration of the in-vehicle device shown in FIG. 1.

FIG. 3 is a block diagram showing a hardware configuration of an in-vehicle gateway shown in FIG. 2.

FIG. 4 is a block diagram showing a hardware configuration of a first server shown in FIG. 1.

FIG. 5 is a block diagram showing a hardware configuration of a second server shown in FIG. 1.

FIG. 6 is a block diagram showing a functional configuration of the in-vehicle gateway shown in FIG. 2.

FIG. 7 is a diagram showing a state in which a scheduled travel route of a vehicle is indicated on a communication record map.

FIG. 8 is a flowchart illustrating processing executed by the in-vehicle gateway.

FIG. 9 is a flowchart illustrating processing executed by the first server.

FIG. 10 is a flowchart illustrating processing executed by the second server.

### DETAILED DESCRIPTION OF EMBODIMENTS

### Problems to be Solved by the Present Disclosure

To normally transmit transmission data when a vehicle is located in an environment with a low wireless communication speed, it is conceivable to reduce the data quality and transmit the data with a reduced data size. However, if the transmitted data does not satisfy the quality required for a service provided by a server, the transmitted data cannot be used appropriately. In this case, the data transmission itself is wasteful.

The in-vehicle communication control device disclosed in JP 2003-61149A is related to downloading of streaming data, and therefore cannot solve the above-described problem related to data transmission (i.e., uploading).

Therefore, an object of the present disclosure is to provide an in-vehicle device, a control method, and a computer program that allow transmission data to be transmitted to an external device without reducing the quality of the transmission data even if a vehicle travels in an environment with a low wireless communication speed.

### Effects of the Present Disclosure

According to the present disclosure, it is possible to provide an in-vehicle device, a control method, and a computer program that allow transmission data to be transmitted to an external device without reducing the quality of the transmission data even if a vehicle travels in an environment with a low wireless communication speed.

### Description of Embodiments of the Present Disclosure

The details of embodiments of the present disclosure will be listed and described. At least some of the embodiments described below may be combined freely.
(1) An in-vehicle device according to a first aspect of the present disclosure is an in-vehicle device mounted in a vehicle, the in-vehicle device including: a communication unit configured to communicate with an external device, and transmit, to the external device, sensor data detected by a sensor mounted in the vehicle; and a buffering control unit configured to determine, according to a speed of wireless communication with the external device performed by the communication unit, whether to perform buffering in which the sensor data is stored in a storage unit without being transmitted by the communication unit, and perform the buffering according to a result of the determination. With this configuration, the in-vehicle device can transmit transmission data to an external device without reducing the quality of the transmission data even if a vehicle travels in an environment with a low wireless communication speed. Accordingly, the external device can maintain its service.
(2) In (1) above, the buffering control unit can be configured to: determine to perform the buffering if a low-speed communication state in which the speed of the wireless communication is less than or equal to a predetermined value occurs in a predetermined range on a scheduled travel route of the vehicle; and perform the buffering while the vehicle is traveling in the predetermined range. This configuration makes it possible to execute necessary and sufficient buffering.
(3) In (2) above, the communication unit may be further configured to receive information transmitted from the external device and representing a required data quality, the required data quality may represent a data capacity per unit time of the sensor data transmitted to the external device from the in-vehicle device, the buffering control unit may be configured to: calculate a predicted time in which the vehicle travels through the predetermined range; calculate, using the predicted time and the required data quality, a storage capacity required for the buffering; and determine whether the calculated storage capacity can be reserved in the storage unit. This configuration makes it possible to efficiently determine whether buffering can be performed.
(4) In (3) above, the buffering control unit may be configured to: in response to the in-vehicle device having approached the predetermined range within a predetermined distance, calculate the predicted time; calculate the storage capacity; and determine whether the storage capacity can be reserved in the storage unit. This configuration makes it possible to accurately determine whether buffering can be performed.
(5) In (3) or (4) above, the buffering control unit may be configured to, if the storage capacity cannot be reserved, cause the communication unit to transmit, to the external device, information indicating that the sensor data cannot be transmitted. With this configuration, the external device need not wait for the sensor data from the in-vehicle sensor, thus making it possible to prevent resources from being wasted.
(6) In any one of (3) to (5) above, the communication unit may be further configured to receive information transmitted from the external device and representing an allowable delay time, the buffering control unit may be configured to, if the predicted time is greater than or equal to the allowable delay time, cause the communication unit to transmit, to the external device, information indicating that the sensor data cannot be transmitted. With this configuration, the external device need not wait for the sensor data from the in-vehicle sensor, thus making it possible to prevent resources from being wasted.
(7) In any one of (1) to (6) above, the communication unit may be further configured to receive a communication record map from outside the in-vehicle device, the communication record map may include, in association with each other, information representing a road, and information representing an actual speed of wireless communication on the road, and the buffering control unit may be configured to: specify, among pieces of the information each representing a road that are included in the communication record map, information representing a road that corresponds to the scheduled travel route; and determine, using the information representing the actual speed that corresponds to the specified information as information representing the speed of the wireless communication, whether to perform the buffering. With this configuration, the in-vehicle device can easily determine the necessity of buffering.
(8) In any one of (1) to (7) above, the buffering control unit may be configured to, if it is not necessary to perform the buffering after the buffering has been performed, cause the communication unit to transmit, to the external device, the sensor data stored in the storage unit by the buffering. With this configuration, the in-vehicle device can transmit the buffered sensor data to the external device, without wasting the sensor data.
(9) A control method according to a second aspect of the present disclosure is a control method of an in-vehicle device mounted in a vehicle, the method including: a communication step of communicating with an external device, and transmitting, to the external device, sensor data detected by a sensor mounted in the vehicle; and a buffering control step of determining, according to a speed of wireless communication with the external device performed in the communication step, whether to perform buffering in which the sensor data is stored in a storage unit without being transmitted in the communication step, and performing the buffering according to a result of the determination. With this configuration, the in-vehicle device can transmit transmission data to an external device without reducing the quality of the transmission data even if a vehicle travels in an environment with a low wireless communication speed. Accordingly, the external device can maintain its service.
(10) A computer program according to a third aspect of the present disclosure is a computer program for causing a computer mounted in a vehicle to implement: a communication function of communicating with an external device, and transmitting, to the external device, sensor data detected by a sensor mounted in the vehicle; and a buffering control function of determining, according to a speed of wireless communication with the external device performed by the communication function, whether to perform buffering in which the sensor data is stored in a storage unit without being transmitted by the communication function, and performing the buffering according to a result of the determination. With this configuration, the computer can transmit transmission data to an external device without reducing the quality of the transmission data even if a vehicle travels in an environment with a low wireless communication speed. Accordingly, the external device can maintain its service.

The present disclosure can be implemented not only as an in-vehicle device including such a distinctive processing unit, but also as a control method including the above-described distinctive processing as steps, or as a program for causing a computer to execute such steps. In addition, the present disclosure can be implemented as a semiconductor integrated circuit that implements part or all of the in-vehicle device, or as a service provision system including the in-vehicle device.

### Details of Embodiments of the Present Disclosure

In the following embodiments, the same components are denoted by the same reference numerals. The names and functions thereof are also the same. Therefore, the detailed descriptions thereof will not be repeated.

### Overall Configuration

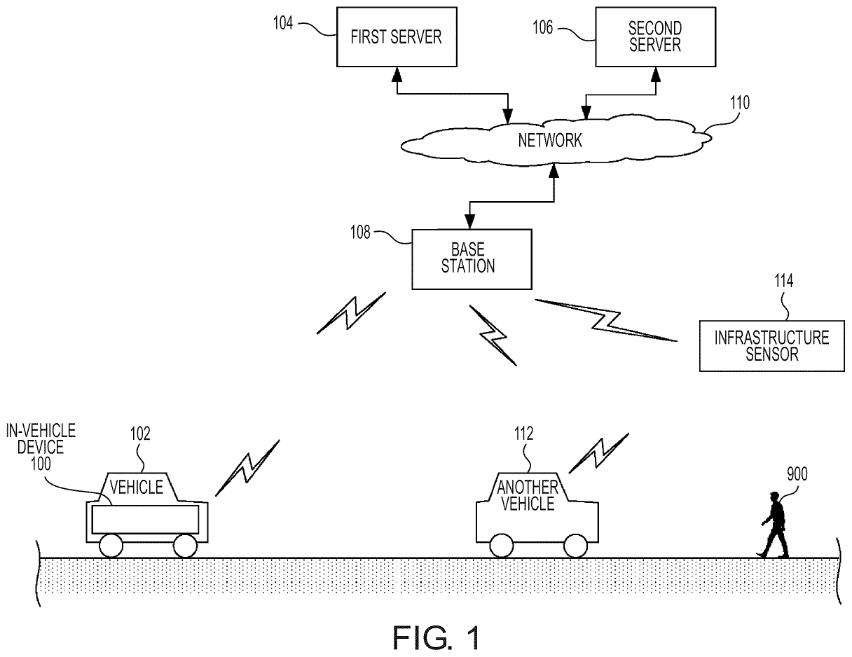

Referring to FIG. 1, an in-vehicle device 100 according to an embodiment of the present disclosure is mounted in a vehicle 102. In response to a request from a first server 104 that provides a service, the in-vehicle device 100 uploads data that may be used for the service. The service provided from the first server 104 is, for example, a remote monitoring service (e.g., monitoring of traffic conditions or monitoring of the vehicle interior state (monitoring of the state of the driver, etc.)). The service provided from the first server 104 may be a service that provides a vehicle with information and the like for assisting the driving of the vehicle. As will be described below, data to be uploaded is sensor data obtained by an in-vehicle sensor mounted in the vehicle 102. Another vehicle 112 having an in-vehicle device mounted therein as in the case of the vehicle 102 is also traveling. The vehicle 102 and the other vehicle 112 transmit wireless communication record data to a second server 106 that generates, manages, and distributes a communication record map. As will be described below, the communication record map is a map in which a road map is divided into a plurality of regions (e.g., rectangular regions) (hereinafter the divided regions are referred to as “areas”), and each of the areas is associated with the communication speed and the signal strength of wireless communication in that area. In response to a request from the in-vehicle device 100, the second server 106 transmits the communication record map to the in-vehicle device 100.

The communication between the in-vehicle device 100, the in-vehicle device (not shown) of the other vehicle 112, the first server 104, and the second server 106 is performed via a base station 108. The base station 108 provides a mobile communication service using, for example, a 4th Generation (4G) line, a 5th Generation (5G) line, and the like. The base station 108 is connected to a network 110. The in-vehicle device 100 of the vehicle 102 and the in-vehicle device of the other vehicle 112 have a communication function according to communication specifications (4G line, 5G line, and the like) that the base station 108 is servicing.

Note that the first server 104 also receives sensor data from an infrastructure sensor 114 fixedly installed on the roadside (i.e., a road (including an intersection) and the vicinity thereof). The infrastructure sensor 114 is, for example, an image sensor (digital monitoring camera, etc.), a radar (millimeter-wave radar, etc.), or a laser sensor (Light Detection and Ranging) (LiDAR), etc.). The infrastructure sensor has a function of communicating with the base station 108, and transmits the obtained sensor data to the first server 104 via the base station 108 and the network 110.

The vehicle 102, the other vehicle 112, the pedestrian 900, and the like are objects to be detected by the infrastructure sensor 114. The vehicle 102 and the other vehicle 112 also have in-vehicle sensors mounted therein. The other vehicle 112 and the pedestrian 900 are objects to be detected by the in-vehicle sensor mounted in the vehicle 102. The vehicle 102 and the pedestrian 900 are objects to be detected by the in-vehicle sensor mounted in the other vehicle 112.

The sensor data obtained by the in-vehicle sensor mounted in the vehicle 102 is transmitted to the first server 104 via the base station 108 and the network 110. The first server 104 analyzes the sensor data received from the vehicle 102 and the infrastructure sensor 114, and uses the sensor data for the service.

FIG. 1 shows one base station 108, one vehicle 102 in which the in-vehicle device 100 is mounted, and one other vehicle 112. However, this is merely an example. Usually, a plurality of base stations are provided. A plurality of vehicles that upload the sensor data to the first server 104 are traveling, and a plurality of other vehicles 112 that upload communication record data to the second server 106 are traveling. There may be a vehicle in which no in-vehicle device is mounted. The vehicle in which no in-vehicle device is mounted is detected as a dynamic object.

### Hardware Configuration of In-Vehicle Device

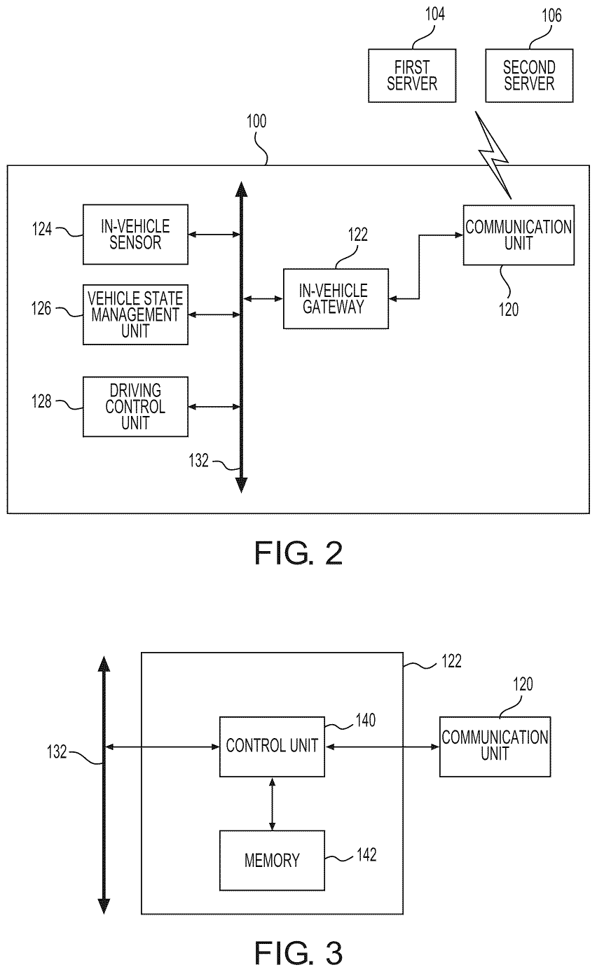

Referring to FIG. 2, an example of the hardware configuration of the in-vehicle device 100 mounted in the vehicle 102 is shown. The in-vehicle device 100 includes a communication unit 120, an in-vehicle gateway 122, an in-vehicle sensor 124, a vehicle state management unit 126, a driving control unit 128, and a bus 132.

The communication unit 120 performs wireless communication (e.g., communication with the first server 104 or the like via the base station 108) with a device external to the vehicle 102. The communication unit 120 includes an integrated circuit (IC) for performing modulation and multiplexing adopted in wireless communication, an antenna for transmitting and receiving radio waves having a predetermined frequency, a radio frequency (RF) circuit, and so forth. The communication unit 120 also has a function of communicating with a global navigation satellite systems (GNSS) such as a global positioning system (GPS). The communication unit 120 may have a communication function such as Wi-Fi.

The in-vehicle gateway 122 plays a role (e.g., communication protocol conversion, etc.) of joining a function of communicating (specifically, communication specifications) with the outside of the vehicle and a communication function (communication specifications) inside the vehicle. As will be described below, when data is uploaded to the first server 104, the in-vehicle gateway 122 executes control to buffer the data to be uploaded according to the state of the wireless communication environment.

The bus 132 serves the communication function inside the vehicle, and mutual communication (i.e., data exchange) between the in-vehicle gateway 122, the in-vehicle sensor 124, the vehicle state management unit 126, and the driving control unit 128 is performed via the bus 132. For the bus 132, for example, a controller area network (CAN) is used.

The in-vehicle sensor 124 is mounted in the vehicle 102, and includes a sensor (a video image capturing device (e.g., a digital camera (a charge-coupled device (CCD) camera or a complementary metal-oxide semiconductor (CMOS) camera)) for obtaining information external to the vehicle 102, a laser sensor (e.g., LiDAR) and the like), and a sensor (e.g., an acceleration sensor and a load sensor) for obtaining information of the vehicle itself. The in-vehicle sensor 124 obtains information within a detection range (in the case of a camera, an imaging range), and outputs the information as sensor data. In the case of a digital camera, digital image data is output. A detection signal (i.e., an analog or digital signal) of the in-vehicle sensor 124 is output as digital data to the bus 132 via an I/F unit (not shown), and is transmitted to the in-vehicle gateway 122.

The vehicle state management unit 126 manages the state (e.g., the position, the traveling speed, the acceleration, and the traveling direction) of the vehicle 102. The position can be obtained with a GPS, for example. The traveling speed, the acceleration, and the traveling direction can be calculated, for example, from chronological positional information and the corresponding time information.

The driving control unit 128 controls the travel of the vehicle 102. The driving control unit 128 is, for example, an autonomous driving electronic control unit (ECU). For example, the driving control unit 128 obtains sensor data from the in-vehicle sensor 124, analyzes the sensor data to grasp the situation of the surroundings of the vehicle 102, and controls mechanisms related to autonomous driving (i.e., mechanisms such as the engine, the transmission, the steering, the brake, etc.). Note that the vehicle 102 is not limited to a vehicle having an automatic driving function. When the vehicle 102 does not have an automatic driving function, the vehicle 102 does not include the driving control unit 128.

Hardware Configuration of In-Vehicle Gateway Referring to FIG. 3, the in-vehicle gateway 122 includes a control unit 140 and a memory 142. The control unit 140 includes a central processing unit (CPU), and controls the memory 142. The memory 142 is, for example, a rewritable nonvolatile semiconductor memory, and stores a computer program (hereinafter simply referred to as a program) executed by the control unit 140. The memory 142 provides a work region for the program executed by the control unit 140. The control unit 140 obtains data to be processed, directly from the communication unit 120, and obtains data to be processed, via the bus 132 from the units other than the communication unit 120. The control unit 140 stores, in the memory 142, the data received from the communication unit 120 and the data received from the bus 132, as necessary. The control unit 140 stores a processing result in the memory 142, and output the processing result to the bus 132.

### Hardware Configuration of First Server

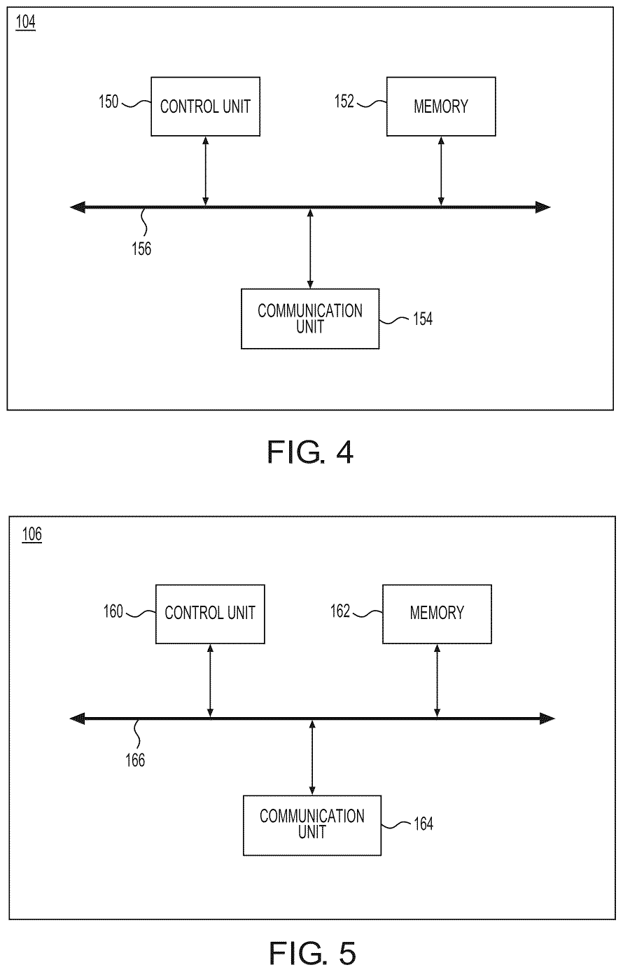

Referring to FIG. 4, the first server 104 includes a control unit 150 that controls various units, a memory 152 that stores data, a communication unit 154 that performs communication, and a bus 156 for exchanging data between the various units. The control unit 150 includes a CPU, and implements functions described below by controlling the various units. The memory 152 includes a rewritable semiconductor nonvolatile memory, and a mass storage device such as a hard disk drive. The communication unit 154 receives, via the base station 108, sensor data uploaded from the in-vehicle device 100 and the infrastructure sensor 114 or the like. The data received by the communication unit 154 is transmitted to the memory 152 and is stored therein. This enables the first server 104 to execute a predetermined service.

### Hardware Configuration of Second Server

Referring to FIG. 5, the second server 106 is configured in the same manner as the first server 104. That is, the second server 106 includes a control unit 160 that controls various units, a memory 162 that stores data, a communication unit 164 that performs communication, and a bus 166 for exchanging data between the various units. The control unit 160 includes a CPU, and implements functions described below by controlling the various units. The memory 162 includes a rewritable semiconductor nonvolatile memory, and a mass storage device such as a hard disk drive. The communication unit 164 receives, via the base station 108, communication record data uploaded from the in-vehicle device or the like mounted in the other vehicle 112. The data received by the communication unit 164 is transmitted to the memory 162 and is stored therein. This enables the second server 106 to generate and manage a communication record map, read out the communication record map from the memory 162 in response to a request from the outside, and distribute the communication record map.

### Functional Configuration of In-Vehicle Gateway

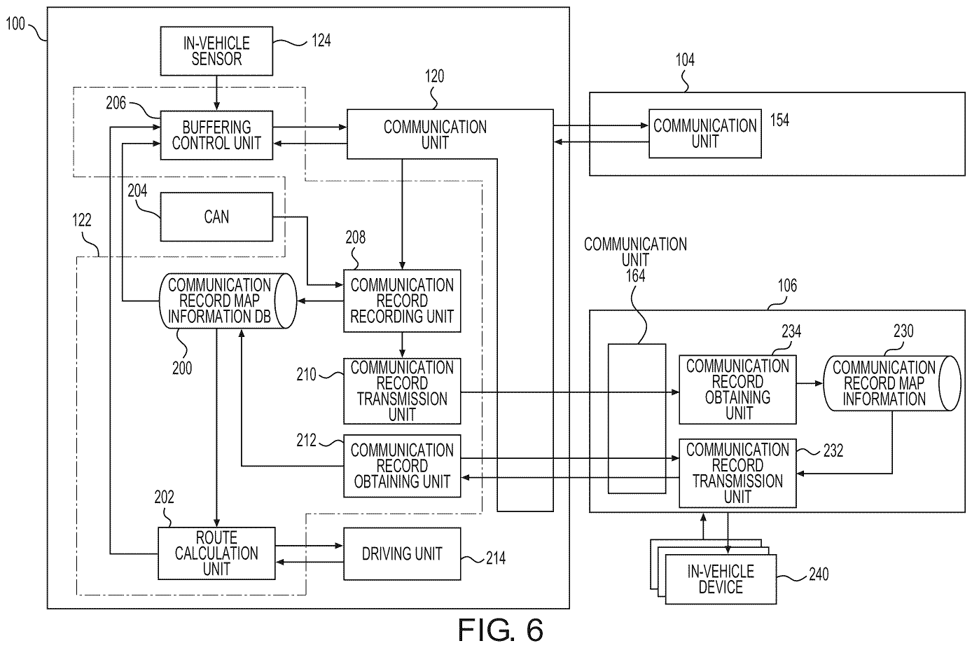

The functions of the in-vehicle gateway 122 relating to the present disclosure will be described. Referring to FIG. 6, the in-vehicle gateway 122 includes a communication record map information database (DB) 200, a route calculation unit 202, a buffering control unit 206 (processor), a communication record recording unit 208, a communication record transmission unit 210, and a communication record obtaining unit 212. FIG. 6 shows part of the hardware configurations shown in FIGS. 2, 4, and 5. A CAN 204 corresponds to the bus 132 shown in FIG. 2, a driving unit 214 corresponds to the vehicle state management unit 126 and the driving control unit 128 shown in FIG. 2. As for the first server 104, the communication unit 154 shown in FIG. 4 is shown. As for the second server 106, the communication unit 164 shown in FIG. 5 is shown, and a communication record map information 230, a communication record transmission unit 232, and a communication record obtaining unit 234 that are related to the functions of the in-vehicle gateway 122 are shown. The communication record map information DB 200 is implemented by the memory 142 (see FIG. 3) of the in-vehicle gateway 122. The other functions of the in-vehicle gateway 122 are implemented by the control unit 140 and the memory 142 (see FIG. 3). The communication record map information DB 200 stores communication record maps. A communication record map is received from the second server 106 as a result of the in-vehicle gateway 122 requesting the communication record map from the second server 106 via the communication unit 120.

The route calculation unit 202 calculates a scheduled travel route of the vehicle 102 in which the in-vehicle device 100 is mounted. The scheduled travel route of the vehicle 102 is calculated, for example, by a car navigation system mounted in the vehicle 102, in response to a destination being set for the car navigation system. The car navigation system can calculate the scheduled travel route with reference to a road map, using the set destination and the current position of the vehicle 102 that can be obtained from the GPS. The route calculation unit 202 obtains the scheduled travel route calculated by the car navigation system from the car navigation system. The route calculation unit 202 may independently obtain positional information or the like of the vehicle 102 from the vehicle state management unit 126 (see FIG. 2) and calculate the scheduled travel route of the vehicle 102 in the same manner as the car navigation system. The route calculation unit 202 outputs information of the calculated scheduled travel route to the buffering control unit 206.

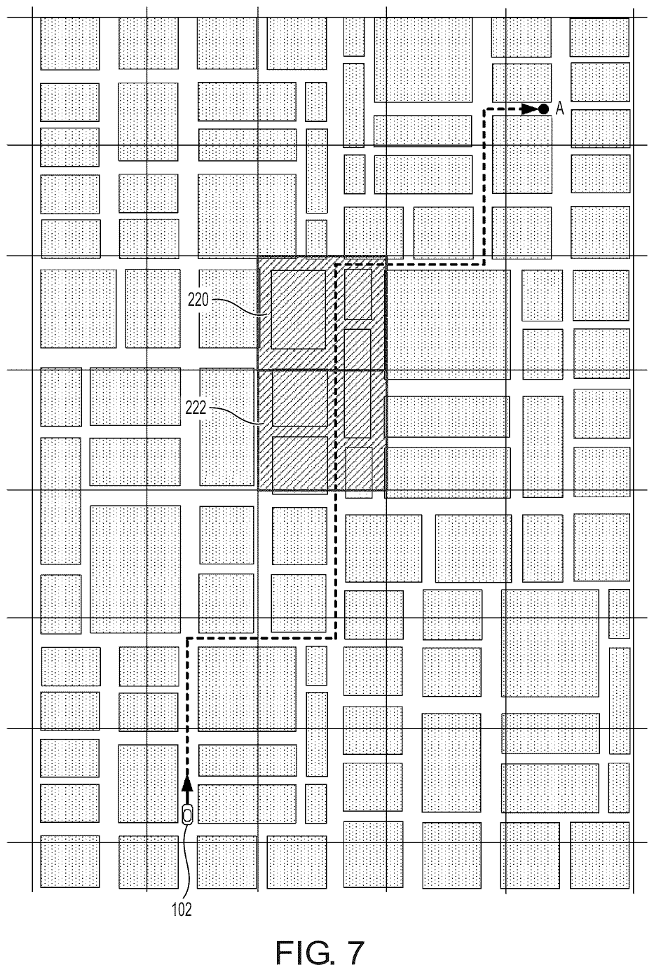

The route calculation unit 202 requests the communication record obtaining unit 212 to transmit information of the scheduled travel route. In response to the request from the route calculation unit 202, the communication record obtaining unit 212 transmits the information of the scheduled travel route to the second server 106 (specifically, the communication record transmission unit 232) via the communication unit 120. For example, referring to FIG. 7, a communication record map is a map in which a road map is divided into a plurality of areas, and each of the areas is associated with the communication speed and the signal strength of wireless communication in that area. For example, the communication speed and the signal strength in each of the areas each have a representative value (e.g., an average value) obtained through statistical processing of communication record data received from in-vehicle devices of vehicles that are traveling in that area during the same time period. The communication record map information 230 of the second server 106 includes, for example, a communication record map for each time period, and the communication record map is stored in the memory 162 (see FIG. 5). As indicated by the dashed arrows in FIG. 7, in the case where a scheduled travel route from the current position of the vehicle 102 to a destination A has been determined, the communication record transmission unit 232 of the second server 106 reads out, from the communication record map information 230, at least a communication record map related to areas in which the dashed arrows are included. The communication record transmission unit 232 transmits the communication record map read out from the communication record map information 230 to the vehicle 102 (specifically, the in-vehicle device 100) via the communication unit 164. The communication record map transmitted to the vehicle 102 from the second server 106 is received by the communication record obtaining unit 212 via the communication unit 120, and is stored in the communication record map information DB 200. Note that the communication record transmission unit 232 of the second server 106 also transmits the communication record map to an in-vehicle device 240 mounted in a vehicle other than the vehicle 102, as in the case of transmission of the communication record map to the in-vehicle device 100.

The buffering control unit 206 reads out the communication record map from the communication record map information DB 200, and determines whether an area with a low wireless communication speed is included in the scheduled travel route input from the route calculation unit 202. For example, the buffering control unit 206 compares the wireless communication speed obtained from the communication record map with a predetermined threshold, specifies an area where the wireless communication speed≤the threshold, and determines whether the specified area overlaps the scheduled travel route. If the specified area overlaps the scheduled travel route, the overlapping portion on the scheduled travel route is specified as a predetermined range for which buffering described below is to be performed. Referring to FIG. 7, for example, it is assumed that the wireless communication speed ≤the threshold in two hatched areas (i.e., a low-speed communication area 220 and a low-speed communication area 222). In that case, the buffering control unit 206 specifies, as the predetermined range for which buffering is to be performed, a portion indicated by dashed lines that is included in the low-speed communication area 220 and the low-speed communication area 222. If the predetermined range is specified, the route calculation unit 202 outputs information representing the predetermined range to the buffering control unit 206. Note that when only a communication record map related to areas in which dashed arrows are included is transmitted from the second server 106, it is not necessary to determine whether the areas where the wireless communication speed ≤the threshold overlap the scheduled travel route. When the communication record map information DB 200 stores a communication record map for each time period, the buffering control unit 206 need only determine whether the area specified as described above overlaps the scheduled travel route, and a time period with a low-speed area overlaps a time period during which the vehicle 102 travels on the scheduled travel route.

The communication record recording unit 208 records, as communication record data, a combination of the result (e.g., a communication speed and a signal strength) of communication performed by the communication unit 120, and the information (e.g., a vehicle state and a vehicle positional information) that can be obtained from the CAN 204. The communication record data recorded by the communication record recording unit 208 is transmitted to the second server 106 from the communication record transmission unit 210 via the communication unit 120. The communication record data transmitted to the second server 106 is received by the communication record obtaining unit 234 via the communication unit 164, and is stored as the communication record map information 230. The communication record data recorded by the communication record recording unit 208 is also stored in the communication record map information DB 200. Accordingly, the communication record map information DB 200 may include a position (i.e., an area) and a communication result for each time period, as well as information in which the state of the vehicle 102 at that time is recorded. Note that the communication record obtaining unit 234 of the second server 106 receives the communication record data also from an in-vehicle device 240 mounted in a vehicle other than the vehicle 102, and stores the communication record data as the communication record map information 230.

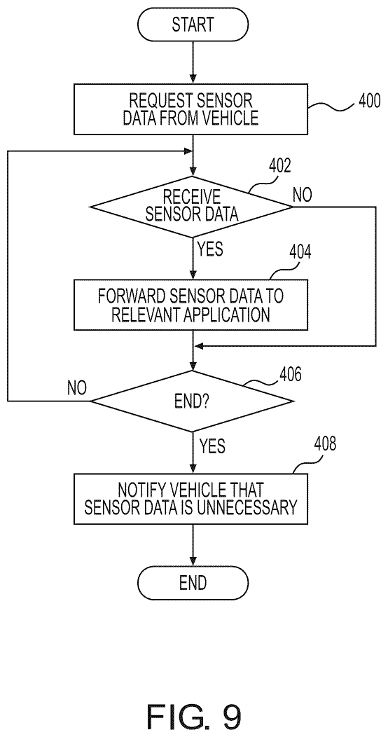

To the buffering control unit 206, sensor data that is output from the in-vehicle sensor 124 mounted in the vehicle 102, and is transmitted via the CAN 204 is input. If the predetermined range cannot be specified, the buffering control unit 206 transmits the input sensor data to the first server 104 via the communication unit 120. The transmitted sensor data is received by the communication unit 154 of the first server 104. Note that a transmission request for the sensor data is transmitted in advance to the in-vehicle device 100 from the communication unit 154 of the first server 104 (see step 400 of FIG. 9 described below). For example, the first server 104 transmits, to the in-vehicle device 100, a transmission request including information representing a data quality required for the service (hereinafter referred to as a required data quality) and an allowable delay time. The buffering control unit 206 transmits sensor data that satisfies the required data quality and the allowable delay to the first server 104. The required data quality may represent, for example, the data capacity per unit time of the sensor data transmitted to the first server 104 from the in-vehicle device 100. The required data quality may be specified by, for example, the resolution and the frame rate of the sensor data. For example, if the in-vehicle sensor 124 is a camera that outputs moving image data, and a plurality of imaging conditions (the resolution and frame rate, etc., of the output data) can be set, then the buffering control unit 206 sets the imaging conditions of the in-vehicle sensor 124 so as to satisfy the required data quality. Whether the allowable delay is satisfied can be determined by, for example, determining whether the time required from the generation (i.e., the output from the in-vehicle sensor 124) of the sensor data in the vehicle 102 to the reception of the sensor data by the first server 104 is less than or equal to the allowable delay time. As will be described below, if the sensor data is to be buffered, whether the above-described required time to which the buffering time is also added is less than or equal to the allowable delay time is determined.

The buffering control unit 206 includes a buffer region (not shown). The buffer region is a storage region reserved for storing the sensor data output from the in-vehicle sensor 124 during buffering described below. The buffer region is implemented by the memory 142 shown in FIG. 3. Upon specifying the predetermined range, the buffering control unit 206 stores (i.e., buffers) the input sensor data in the buffer region, without transmitting the sensor data to the first server 104. The buffering control unit 206 performs the buffering while the vehicle 102 is traveling in the predetermined range. Thereafter, after the vehicle 102 has completed traveling through the predetermined range, the buffering control unit 206 transmits in bulk (hereinafter referred to as “collective transmission”), to the first server 104, the sensor data that has been buffered in the buffer region. Subsequently, the buffering control unit 206 transmits, to the first server 104, sensor data that has been newly input via the CAN 204 in the manner described above.

In order for the vehicle 102 to buffer the sensor data while traveling in the predetermined range, an appropriate storage capacity needs to be reserved as the buffer region in the memory 142. For that purpose, the buffering control unit 206 predicts a time required for the vehicle 102 to travel through the predetermined range, calculates a capacity of the buffer region (hereinafter also referred to as a buffer capacity) from the time that has been predicted (hereinafter referred to as a predicted time) and the required data quality, and reserves the calculated capacity amount in the memory 142. For example, the buffering control unit 206 calculates the distance of the predetermined range from the information representing the predetermined range, obtains the traveling speed of the vehicle 102 from the driving unit 214 (specifically, the vehicle state management unit 126 (see FIG. 2)), and divides the distance of the predetermined range by the traveling speed to calculate the predicted time. For example, the buffering control unit 206 multiplies all of the frame rate (i.e., the number of frames per minute), the resolution of one frame (i.e., the number of pixels of one frame), the data size (e.g., in bytes) of one pixel, and the predicted time in seconds to calculate the lower limit of the buffer capacity. Note that if the buffer region for the calculated capacity amount cannot be reserved, the buffering will not be performed. In that case, for example, the buffering control unit 206 notifies the first server 104 that the buffering cannot be performed. Thus, the first server 104 that has requested uploading of the sensor data can, without waiting for the sensor data that cannot be received, allocate the resource that would have been used otherwise to another processing.

Note that the sensor data to be collectively transmitted may satisfy the allowable delay time as described above. If the sensor data stored in the buffer region does not satisfy the allowable delay time, the buffering control unit 206 will not perform collective transmission. In that case as well, the buffering control unit 206 notifies the first server 104 that the buffering cannot be performed. Thus, the first server 104 that has requested uploading of the sensor data can, without waiting for the sensor data that cannot be received, allocate the resource that would have been used otherwise to another processing.

Thereby, the in-vehicle gateway 122 determines, according to the speed of wireless communication with the first server 104 performed by the communication unit 120 that transmits the sensor data of the in-vehicle sensor 124, whether to perform buffering in which the sensor data is stored in the memory 142 without being transmitted, and performs the buffering according to a result of the determination. That is, the in-vehicle gateway 122 reserves a storage capacity for the buffering in the memory 142 (see FIG. 3) if the scheduled travel route of the in-vehicle device 100 includes a predetermined range in which a low-speed communication state occurs, and buffers the sensor data while the vehicle 102 is traveling in the predetermined range. Thereafter, when the vehicle 102 has passed through the predetermined range in which a low-speed communication state occurs, the in-vehicle gateway 122 collectively transmits the buffered sensor data. Thus, even if the vehicle 102 travels in an environment with a low wireless communication speed, the in-vehicle device 100 can transmit sensor data to the first server 104 without reducing the quality of the transmitted sensor data. Accordingly, the first server 104 can maintain its service. By collectively transmitting the buffered sensor data, the in-vehicle device 100 can transmit the buffered sensor data to the first server 104 without wasting the sensor data. Note that the scheduled travel route may be calculated by a device (e.g., a server that has received a request from the in-vehicle device 100) external to the vehicle 102, and may be transmitted to the in-vehicle device 100 from the external device.

As described above, the buffering control unit 206 determines to perform buffering if a low-speed communication state in which the wireless communication speed is less than or equal to a predetermined value occurs in a predetermined range on the scheduled travel route, and performs the buffering while the vehicle 102 is traveling in the predetermined range. This enables the in-vehicle device 100 to execute necessary and sufficient buffering of sensor data.

As described above, the in-vehicle device 100 receives, via the communication unit 120, information transmitted from the first server 104 and representing a required data quality. Then, the buffering control unit 206 calculates a predicted time for the vehicle 102 to travel through the predetermined range, and determines, using the predicted time and the required data quality, whether the buffer capacity required for the buffering can be reserved in the memory 142. If the storage capacity required for the buffering can be reserved in the memory 142, the buffering control unit 206 reserves the storage capacity in the memory 142. This makes it possible to efficiently determine whether the buffering can be performed.

As described above, the in-vehicle device 100 receives a communication record map from the second server 106 via the communication unit 120. Then, the buffering control unit 206 specifies, from among roads included in the communication record map, a road corresponding to the scheduled travel route, and determines whether to perform the buffering, using the actual speed corresponding to the specified road as the wireless communication speed. This enables the in-vehicle device 100 to easily determine the necessity of the buffering.

### Operations of In-Vehicle Gateway

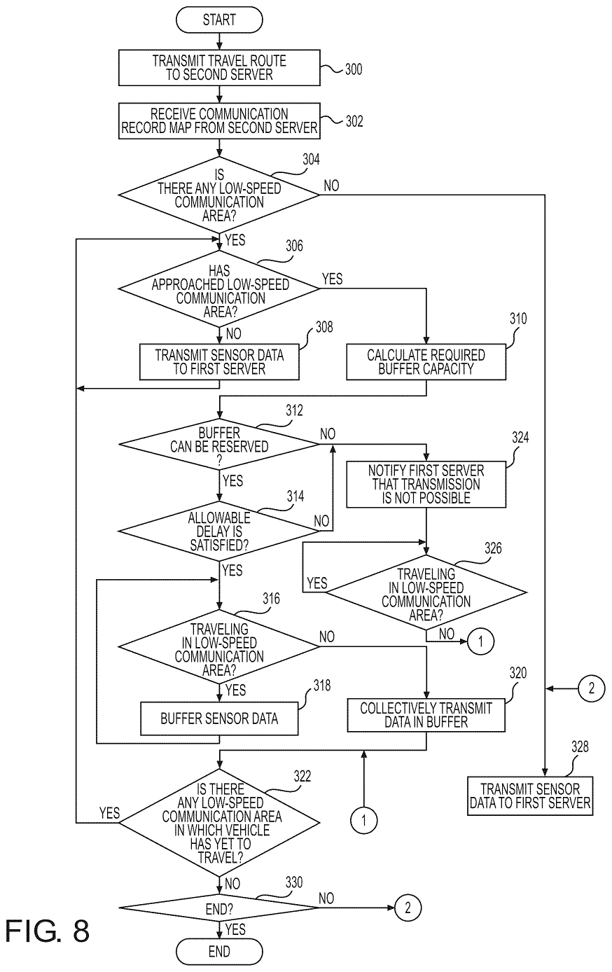

Referring to FIG. 8, operations of the in-vehicle gateway 122 will be described with reference to the functions shown in FIG. 6. The processing illustrated in FIG. 8 is implemented by the control unit 140 (see FIG. 3) reading out a predetermined program from the memory 142, and executing the program. It is assumed that a transmission request for sensor data is transmitted in advance to the in-vehicle device 100 from the first server 104.

Referring to FIG. 8, in step 300, the control unit 140 transmits information representing a scheduled travel route to the second server 106, and requests transmission of a communication record map. This request is performed by, for example, transmitting the information representing the scheduled travel route with a predetermined request code added thereto. As described above, the in-vehicle gateway 122 obtains the travel route, for example, from a car navigation system mounted in the vehicle 102. Thereafter, the control proceeds to step 302.

In step 302, the control unit 140 receives the communication record map from the second server 106. As described above, the received communication record map includes the transmitted scheduled travel route. The control unit 140 stores the received communication record map in the communication record map information DB 200 (see FIG. 6). Thereafter, the control proceeds to step 304.

In step 304, the control unit 140 determines whether any low-speed communication area is included in the scheduled travel route. Specifically, the control unit 140 determines whether an area in which the communication speed is less than or equal to a threshold is included in the communication record map received in step 302, and, if the area is included, determines whether the scheduled travel route overlaps the area. If it is determined that the scheduled travel route overlaps the area, the control unit 140 specifies the overlapping portion (i.e., the predetermined range). That is, if the predetermined range is specified, it is determined that the low-speed communication area is included, and the control proceeds to step 306. Otherwise (i.e., if the predetermined range is not specified), the control proceeds to step 328. The processing of step 304 corresponds to the function of the buffering control unit 206 shown in FIG. 6.

In step 306, the control unit 140 determines whether the vehicle 102 has approached the low-speed communication area (i.e., the predetermined range on the scheduled travel route specified in step 304). If it is determined that the vehicle 102 has approached the low-speed communication area, the control proceeds to step 310. Otherwise, the control proceeds to step 308. The expression “has approached the low-speed communication area” means that the distance to the predetermined range from the vehicle 102 has become less than or equal to a predetermined distance. The predetermined distance can be set to a value within the range from 100 m to 10 m, for example.

In step 308, the control unit 140 transmits, to the first server 104 via the communication unit 120, the sensor data input to the communication record map information DB 200. This corresponds to the function of the buffering control unit 206 shown in FIG. 6. Thereafter, the control returns to step 306, in which the above-described processing is repeated.

When the vehicle 102 has approached the low-speed communication area (i.e., the predetermined range), the control unit 140, in step 310, calculates a storage capacity required to buffer the sensor data. As described above with respect to the buffering control unit 206, the control unit 140 calculates the necessary capacity amount of the buffer region from the required data quality and the time required to travel through the predetermined range (i.e., the predicted time). Thereafter, the control proceeds to step 312. In this manner, by calculating the buffer capacity when the vehicle 102 has approached the low-speed communication area (i.e., the predetermined range), whether the buffering can be performed can be determined more accurately than by calculating the buffer capacity while the vehicle 102 is traveling in a location far from the low-speed communication area. The free capacity of the memory 142 for reserving the buffer region changes while the vehicle 102 is traveling. Accordingly, if the free capacity of the memory 142 when the vehicle 102 has approached the low-speed communication area is smaller than that when the vehicle 102 is traveling in a location remote from the low-speed communication area, there is the possibility that the calculated buffer capacity cannot be reserved during traveling in the remote location, and that the buffering cannot be executed.

In step 312, the control unit 140 determines whether the buffer capacity calculated in step 310 can be reserved in the memory 142. This processing corresponds to the function of the buffering control unit 206 shown in FIG. 6 described above. If it is determined that the buffer capacity can be reserved, the control proceeds to step 314. Otherwise, the control proceeds to step 324.

In step 314, the control unit 140 determines whether the sensor data to be buffered satisfies the allowable delay. This processing corresponds to the function of the buffering control unit 206 shown in FIG. 6. If it is determined that the sensor data satisfies the allowable delay, the control proceeds to step 316. Otherwise, the control proceeds to step 324.

In step 316, the control unit 140 determines whether the vehicle 102 has started traveling in the low-speed communication area (i.e., the predetermined range), and is currently traveling in the low-speed communication area. If it is determined that the vehicle 102 is traveling in the low-speed communication area, the control proceeds to step 318. Otherwise (i.e., if the vehicle 102 has passed through the low-speed communication area), the control proceeds to step 320.

In step 318, the control unit 140 buffers the sensor data output from the in-vehicle sensor 124. That is, the control unit 140 stores the sensor data output from the in-vehicle sensor 124 in the buffer region (specifically, the memory 142 in FIG. 6) of the buffering control unit 206 without transmitting the sensor data to the first server 104. Thereafter, the control returns to step 316. At this time, the sensor data is stored chronologically, or in other words, such that the chronological order in which the sensor data has been generated can be determined (e.g., with time information added thereto).

If the result of the determination in step 316 is NO, or in other words, if the vehicle 102 has passed through the low speed communication area, the control unit 140, in step 320, reads out the sensor data stored in the buffer region of the buffering control unit 206, and collectively transmits the sensor data to the first server 104 via the communication unit 120. Note that the collective transmission means that all pieces of the sensor data stored in the buffer region of the buffering control unit 206 are transmitted before new sensor data output from the in-vehicle sensor 124 is transmitted to the first server 104. Thereafter, the control proceeds to step 322.

In step 322, the control unit 140 determines whether, among the low-speed communication areas (i.e., the predetermined ranges) detected in step 304, there is any low speed communication area in which the vehicle 102 has yet to travel. This processing is necessitated by the fact that a plurality of low-speed communication areas are detected in step 304. If it is determined that there is any low-speed communication area in which the vehicle 102 has yet to travel, the control returns to step 306. Otherwise, the control proceeds to step 330.

If the result of the determination in one of step 312 and step 314 is NO, the control unit 140, in step 324, transmits, to the first server 104, information indicating that the sensor data cannot be transmitted. Thereafter, the control proceeds to step 326.

In step 326, the control unit 140, as in step 316, determines whether the vehicle 102 has started traveling the low speed communication area, and is currently traveling in the low-speed communication area. Until it is determined to be NO (i.e., until the vehicle 102 has passed through the low-speed communication area), step 326 is repeated. Accordingly, during this step, the sensor data is neither transmitted to the first server 104, nor buffered. If it is determined to be NO, the control proceeds to step 322.

If the result of the determination in step 304 is NO (i.e., if there is no low-speed communication area on the scheduled travel route), the control unit 140, in step 328, transmits, to the first server 104 via the communication unit 120, the sensor data output from the in-vehicle sensor 124. Thereafter, the control proceeds to step 330.

In step 330, the control unit 140 determines whether to end the control. Specifically, the control unit 140 determines whether the vehicle 102 has completed traveling through the scheduled travel route (e.g., has arrived at the destination A in FIG. 7). If it is determined that the traveling has been completed, the program ends. Otherwise, the control returns to step 328. Note that the control unit 140 may also determine to end the control in response to receiving, from the first server 104, a notification indicating that the transmission of the sensor data is unnecessary.

For example, if there is no low-speed communication area on the scheduled travel route (if the result of the determination in step 304 is NO), step 328 and step 330 are repeated while the vehicle 102 is traveling on the scheduled travel route. On the other hand, if there is any low-speed communication area on the scheduled travel route (if the result of the determination in step 304 is YES), the buffering is performed where possible while the vehicle 102 is traveling in each low-speed communication area. After performing the collective transmission, step 328 and step 330 are repeated while the vehicle 102 is traveling on the rest of the scheduled travel route. If the buffering cannot be performed although there is any low-speed communication area on the scheduled travel route, neither the transmission nor the buffering of the sensor data is performed while the vehicle 102 is traveling each low-speed communication area (see step 326). After the vehicle 102 has passed through the last low-speed communication area, step 328 and step 330 are repeated while the vehicle 102 is traveling on the rest of the scheduled travel route.

Thereby, the in-vehicle gateway 122 reserves a storage capacity for buffering in the memory 142 if the scheduled travel route of the in-vehicle device 100 includes any low speed communication area, and buffers the sensor data while the vehicle 102 is traveling in the low-speed communication area (see step 318). Thereafter, when the vehicle 102 has passed through the low-speed communication area (if the result of the determination in step 316 is NO), the in-vehicle gateway 122 collectively transmits the buffered sensor data (see step 320). Thus, even if the vehicle 102 travels in an environment with a low wireless communication speed, the in-vehicle device 100 can transmit sensor data to the first server 104 without reducing the quality of the transmitted sensor data. Accordingly, the first server 104 can maintain its service. By collectively transmitting the buffered sensor data, the in-vehicle device 100 can transmit the buffered sensor data to the first server 104 without wasting the sensor data.

Note that in the case where a destination is newly set, and a scheduled travel route of the vehicle 102 is newly determined, the in-vehicle gateway 122 again executes the program illustrated in FIG. 8.

### Operations of First Server

Referring to FIG. 9, operations performed by the first server 104, or in other words, the function of receiving sensor data from the in-vehicle device 100 and providing the service will be described. The processing illustrated in FIG. 9 is implemented by the control unit 150 of the first server 104 shown in FIG. 4 reading out a predetermined program from the memory 152 and executing the program.

In step 400, the control unit 150 requests a plurality of vehicles (specifically, in-vehicle devices) to transmit sensor data. Thereafter, the control proceeds to step 402. The transmission of this request may be performed via broadcast, for example. At this time, the control unit 150 transmits a transmission request including the information representing the required data quality and the allowable delay time as described above. In response to this, as described above, the in-vehicle gateway 122 of the in-vehicle device 100 transmits, to the first server 104, the sensor data output from the in-vehicle sensor 124 mounted in the vehicle 102, and executes the program illustrated in FIG. 8 if the scheduled travel route is specified.

In step 402, the control unit 150 determines whether the sensor data has been received. If it is determined that the sensor data has been received, the control proceeds to step 404. Otherwise, the control proceeds to step 406.

In step 404, the control unit 150 forwards the received sensor data to an application (i.e., a program) of the corresponding service (e.g., a remote monitoring service) executed by the first server 104. Thereafter, the control proceeds to step 406.

In step 406, the control unit 150 determines whether an end instruction has been received. The end instruction is made by, for example, an operation unit (not shown) of a keyboard or mouse included in the first server 104 being operated. If it is determined to end the control, the control proceeds to step 408. Otherwise, the control returns to step 402, in which the above-described processing is repeated.

In step 408, the control unit 150 transmits, to a vehicle that has been requested to transmit the sensor data in step 400, a notification indicating that the transmission of the sensor data is unnecessary. The transmission of the request may be performed via broadcast, for example. Thereafter, the program ends.

Thereby, the first server 104 can provide its service, using the sensor data uploaded from the in-vehicle device of the vehicle. In response to the scheduled travel route of the vehicle 102 being calculated during uploading of the sensor data to the first server 104, the in-vehicle device 100 buffers the sensor data while the vehicle 102 is traveling in a low-speed communication area, and collectively transmits the buffered sensor data when the vehicle 102 has pass through the low-speed communication area. Thus, even if the vehicle 102 travels in an environment with a low wireless communication speed, the in-vehicle device 100 can transmit sensor data to the first server 104 without reducing the quality of the transmitted sensor data. Accordingly, the first server 104 can maintain its service.

### Operations of Second Server

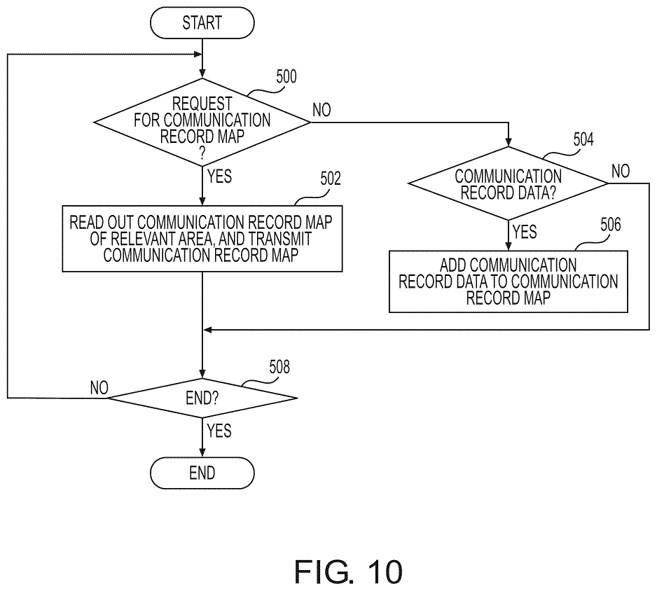

Referring to FIG. 10, operations performed by the second server 106, or in other words, the function of generating a communication record map, and transmitting the communication record map in response to a request will be described. The processing in illustrated FIG. 10 is implemented by the control unit 160 of the second server 106 shown in FIG. 5 reading out a predetermined program from the memory 162 and executing the program. The communication record map is stored in the memory 162.

In step 500, the control unit 160 determines whether a request for a communication record map has been received. If it is determined that the request has been received, the control proceeds to step 502. Otherwise, the control proceeds to step 504. For example, as described above, transmission of a communication record map with the information representing the scheduled travel route added thereto is requested from the in-vehicle device 100, (see step 300 in FIG. 8). If this request has been received, the control unit 160 makes a determination YES.

In step 502, the control unit 160 reads out, from the memory 162, the communication record map of the relevant area that corresponds to the request, and transmits the communication record map. The transmission destination can be specified by a transmission source address (e.g., IP address) received in step 500. Thereafter, the control proceeds to step 508.

If the result of the determination in step 500 is NO, the control unit 150, in step 504, determines whether communication record data has been received. If it is determined that communication record data has been received, the control proceeds to step 506. Otherwise, the control proceeds to step 508. The communication record data is, for example, data representing the state (e.g., the communication speed and the signal strength) of the actual wireless communication on each road. For example, the in-vehicle device of each vehicle chronologically stores, as the communication record data, the communication speeds and the signal strengths when the in-vehicle device performs wireless communication with an external entity, with positional information added thereto, and periodically transmits the stored communication record data to the second server 106.

In step 506, the control unit 160 stores, in the memory 162, the communication record data received in step 504. At this time, the control unit 160 updates the existing communication record map as necessary, using the received new communication record data. Thereafter, the control proceeds to step 508.

In step 508, the control unit 160 determines whether an end instruction has been received. The end instruction is made by, for example, an operation unit (not shown) of a keyboard or mouse included in the second server 106 being operated. If it is determined to end the control, the program ends. Otherwise, the control returns to step 500, in which the above-described processing is repeated.

Thereby, the second server 106 can generate and update a communication record map, using the communication record data uploaded from the in-vehicle device of each vehicle, and transmit the communication record map in response to a request. During uploading of the sensor data to the first server 104, the in-vehicle device 100 can easily determine, using the communication record map received from the second server 106, whether any low-speed communication area is included in the scheduled travel route of the vehicle 102. In response to the scheduled travel route being calculated, the in-vehicle device 100 buffers the sensor data while the vehicle 102 is traveling in the low-speed communication area, and collectively transmits the buffered sensor data when the vehicle 102 has passed through the low-speed communication area. Thus, even if the vehicle 102 travels in an environment with a low wireless communication speed, the in-vehicle device 100 can transmit sensor data to the first server 104 without reducing the quality of the transmitted sensor data.

The foregoing has described a case where the buffer capacity is calculated when the vehicle 102 has approached a low-speed communication area (i.e., a predetermined range); however, the present disclosure is not limited thereto. The buffer capacity may be calculated when a scheduled travel route has been calculated, and then the communication record map corresponding to the scheduled travel route has been obtained. For example, if the scheduled travel route is relatively short, the vehicle 102 can travel through the scheduled travel route in a relatively short time, and the amount of change in the free capacity of the memory 142 is relatively small. Therefore, the buffer capacity may be calculated in advance, well before the vehicle 102 approaches the low-speed communication area.

The foregoing has described a case where the in-vehicle device 100 obtains a wireless communication speed on the scheduled travel route, using the communication record map received from the second server 106; however, the present disclosure is not limited thereto. The in-vehicle device need only be able to obtain a wireless communication speed on the scheduled travel route of the vehicle 102 from an external entity. For example, the vehicle 102 may specify a wireless communication speed on the scheduled travel route of the vehicle 102, using a map (e.g., area maps of 5G and Long Term Evolution (LTE)) related to wireless communication speeds that is provided by a wireless communication service company or the like.

The foregoing has described a case where the in-vehicle device 100 and the in-vehicle device of another vehicle 112 transmit the communication record data to the second server 106; however, the present disclosure is not limited thereto. The in-vehicle device 100 need not store the communication record data, and need not transmit the communication record data to the second server 106. In that case, the in-vehicle device 100 need not include the communication record recording unit 208 and the communication record transmission unit 210.

Note that various types of processing (various functions) of the above-described embodiment may be implemented by processing circuitry including one or more processors. The processing circuitry may be configured by an integrated circuit or the like in which, in addition to the one or more processors, any of one or more memories, various analog circuits, and various digital circuits are combined. The one or more memories store a program (instruction) for causing the one or more processors to execute the various types of processing. The one or more processors may execute the various types of processing in accordance with the program read out from the one or more memories, or may execute the various types of processing in accordance with a logic circuit designed in advance to execute the various types of processing. The processors may be various processors adapted to control a computer, including, for example, a CPU, a graphics processing unit (GPU), a digital signal processor (DSP), a field programmable gate array (FPGA), and an application specific integrated circuit (ASIC). Note that the above-described plurality of processors that are physically separated may cooperate with each other to execute the various types of processing. For example, the processors respectively mounted in a plurality of physically separated computers may cooperate with each other to execute the various types of processing via a network such as a local area network (LAN), a wide area network (WAN), and the Internet.

It is possible to provide a recording medium having recorded thereon a program for causing a computer to execute the processing of the in-vehicle device 100 (specifically, the processing executed by the in-vehicle gateway 122 (e.g., the processing illustrated in FIG. 8)). The recording medium is, for example, an optical disk (digital versatile disc (DVD) or the like) or a removable semiconductor memory (universal serial bus (USB) memory or the like). While a computer program can be transmitted via a communication line, the recording medium means a non-transitory recording medium. As described above, even when the state of the external environment of the in-vehicle device deteriorates, the computer can maintain a cloud collaboration service by causing the computer to read the program stored on the recording medium, thus making it possible to provide the service from a server.

### Appendix

That is, a computer-readable non-transitory recording medium stores a computer program for causing a computer mounted in a vehicle to implement:
a communication function of communicating with an external device, and transmitting, to the external device, sensor data detected by a sensor mounted in the vehicle; and
a buffering control function of determining, according to a speed of wireless communication with the external device performed by the communication function, whether to perform buffering in which the sensor data is stored in a storage unit without being transmitted by the communication function, and performing the buffering according to a result of the determination.

Although the present disclosure has been described above through descriptions of embodiments, the foregoing embodiments are merely illustrative, and the present disclosure is not limited only to the foregoing embodiments. The scope of the present disclosure is defined by the claims in consideration of the detailed description of the disclosure, and includes all modifications which fall within the meaning and scope equivalent to the wording recited therein.

1. An in-vehicle device mounted in a vehicle, the in-vehicle device comprising:
a communication unit configured to communicate with an external device, and transmit, to the external device, sensor data detected by a sensor mounted in the vehicle; and
a processor configured to determine, according to a speed of wireless communication with the external device performed by the communication unit, whether to perform buffering in which the sensor data is stored in a memory without being transmitted by the communication unit, and perform the buffering according to a result of the determination.

2. The in-vehicle device according to claim 1, wherein
the processor is configured to:
determine to perform the buffering if a low-speed communication state in which the speed of the wireless communication is less than or equal to a predetermined value occurs in a predetermined range on a scheduled travel route of the vehicle; and
perform the buffering while the vehicle is traveling in the predetermined range.

3. The in-vehicle device according to claim 2, wherein
the communication unit is further configured to receive information transmitted from the external device and representing a required data quality,
the required data quality represents a data capacity per unit time of the sensor data transmitted to the external device from the in-vehicle device, and
the processor is configured to:
calculate a predicted time in which the vehicle travels through the predetermined range;
calculate, using the predicted time and the required data quality, a storage capacity required for the buffering; and
determine whether the calculated storage capacity can be reserved in the memory.

4. The in-vehicle device according to claim 3, wherein
the processor is configured to, in response to the in-vehicle device having approached the predetermined range within a predetermined distance,
calculate the predicted time;
calculate the storage capacity; and
determine whether the storage capacity can be reserved in the memory.

5. The in-vehicle device according to claim 3, wherein
the processor is configured to, if the storage capacity cannot be reserved, cause the communication unit to transmit, to the external device, information indicating that the sensor data cannot be transmitted.

6. The in-vehicle device according to claim 3, wherein
the communication unit is further configured to receive information transmitted from the external device and representing an allowable delay time,
the processor is configured to, if the predicted time is greater than or equal to the allowable delay time, cause the communication unit to transmit, to the external device, information indicating that the sensor data cannot be transmitted.

7. The in-vehicle device according to claim 1, wherein
the communication unit is further configured to receive a communication record map from outside the in-vehicle device,
the communication record map includes, in association with each other, information representing a road, and information representing an actual speed of wireless communication on the road, and
the processor is configured specify, to:
specify, among pieces of the information each representing a road that are included in the communication record map, information representing a road that corresponds to the scheduled travel route; and
determine, using the information representing the actual speed that corresponds to the specified information as information representing the speed of the wireless communication, whether to perform the buffering.

8. The in-vehicle device according to claim 1, wherein
the processor is configured to, if it is not necessary to perform the buffering after the buffering has been performed, cause the communication unit to transmit, to the external device, the sensor data stored in the memory by the buffering.

9. A control method of an in-vehicle device mounted in a vehicle, the method comprising:
communicating with an external device, and transmitting, to the external device, sensor data detected by a sensor mounted in the vehicle; and
determining, according to a speed of wireless communication with the external device, whether to perform buffering in which the sensor data is stored in a memory without being transmitted to the external device, and performing the buffering according to a result of the determination.

10. A storage medium that stores a computer program that causes a computer mounted in a vehicle to perform the following steps:
communicating with an external device, and transmitting, to the external device, sensor data detected by a sensor mounted in the vehicle; and
determining, according to a speed of wireless communication with the external device, whether to perform buffering in which the sensor data is stored in a memory without being transmitted to the external device, and performing the buffering according to a result of the determination.
